(19) United States
(12) Patent Application Publication
(10) Pub. No.: US 2010/0312919 A1
(43) Pub. Date: Dec. 9, 2010

(54) MOBILE TERMINAL AND METHOD FOR CONTROLLING THE MOBILE TERMINAL TO BE USED THROUGH HOST

(76) Inventors: Uee Song LEE, Seoul (KR); Seung Won Lee, Seoul (KR); Ju Ho Ha, Seoul (KR); Kyung Hwan Kim, Suwon-si (KR); Jong Pil Won, Seoul (KR); Jung Su Lee, Seoul (KR)

Correspondence Address: BIRCH STEWART KOLASCH & BIRCH, PO BOX 747, FALLS CHURCH, VA, 22040-0747, US

(21) Appl. No.: 12/636,443

(22) Filed: Dec. 11, 2009

(30) Foreign Application Priority Data
Jun. 9, 2009 (KR) 10-2009-0051051

(51) Int. Cl. G06F 3/00; G06F 9/46; G06F 13/42; G06F 13/00

(52) U.S. Cl. 710/14; 719/327; 710/105; 710/300

(57) ABSTRACT

A mobile terminal and a method for controlling the mobile terminal to be used through a host device are disclosed. The method for controlling the mobile terminal to be used through the host device includes transmitting a virtualization engine and driver programs of user modes of the mobile terminal to the host device; selecting one of the user modes; and transmitting information of the selected one user mode to the host device, wherein the transmitted virtualization engine is recognized as a part of an operating system (OS) of the host device, and is programmed to drive a driver program corresponding to each of the user modes within the host device.

This application claims the benefit of Korean Patent Application No. 10-2009-0051051, filed on Jun. 9, 2009, which is hereby incorporated by reference as if fully set forth herein.

### BACKGROUND OF THE INVENTION

1. Field of the Invention

The present invention relates to a mobile terminal, and more particularly to a method for controlling a mobile terminal to be used through a host device, and a method for controlling the host device.

2. Discussion of the Related Art

In recent times, a mobile terminal has been widely used as a communication device. There are a variety of mobile terminals, for example, a mobile phone, a personal digital assistant (PDA), a smart phone, etc. In addition to such mobile terminals, personal information processing devices (hereinafter referred to as host devices), such as a personal computer (PC) and a notebook computer, have also been widely used as such communication devices.

The mobile terminal and the host device have rapidly developed to increase user convenience. In recent times, the demand for increased user convenience by interconnecting the mobile terminal and the host device is increasing. For example, the mobile terminal is connected to the host device, so as to allow a function used in the mobile terminal to be implemented in the host device.

However, in order to implement the function of the mobile terminal in the host device according to most conventional schemes, an additional installation program (hereinafter referred to as a driver program or drive software) must be initially installed in the host device. As a result, a user must use an additional installation program to connect the mobile terminal with the host device, or must directly check whether a corresponding installation program has already been installed in the host device, resulting in greater user inconvenience.

### SUMMARY OF THE INVENTION

Accordingly, the present invention is directed to a mobile terminal and a method for controlling the mobile terminal to be used through a host device that substantially obviate one or more problems due to limitations and disadvantages of the related art.

An object of the present invention is to provide a method for controlling a mobile terminal to be effectively used through a host device, and a method for controlling the host device.

Technical subject matters to be realized by embodiments of the present invention are not limited to the following technical subject matters, and other technical subject matters not mentioned in the following description may be easily appreciated by those skilled in the art to which the present invention pertains without difficulty.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for controlling a mobile terminal to be used through a host device includes recognizing a communication connection to the host device, transmitting a virtualization engine and driver programs of individual user modes to the host device, and selecting one of the user modes, and transmitting information of the selected user mode to the host device, wherein the transmitted virtualization engine is recognized as a part of an operating system (OS) of the host device, and is programmed to drive a driver program corresponding to each of the user modes within the host device.

In accordance with another aspect of the present invention, a method for controlling a mobile terminal to be used through a host device includes recognizing a communication connection to the host device, selecting one of the user modes, and transmitting information of the selected user mode to the host device, and transmitting a virtualization engine and a driver program corresponding to the user mode to the host device, wherein the transmitted virtualization engine is recognized as a part of an operating system (OS) of the host device, and is programmed to drive a driver program corresponding to each of the user modes within the host device.

In accordance with another aspect of the present invention, a method for controlling a mobile terminal to be used through a host device includes selecting a user mode, recognizing a communication connection to the host device, and transmitting a virtualization engine and a driver program corresponding to the user mode to the host device, wherein the transmitted virtualization engine is recognized as a part of an operating system (OS) of the host device, and is programmed to drive a driver program corresponding to the user mode within the host device.

In accordance with another aspect of the present invention, a mobile terminal includes a display unit for providing a display image where user modes are selected, a storage unit for storing a virtualization engine and a plurality of programs implementing the user modes, and a controller which recognizes a communication connection to an external host device, transmits the virtualization engine and the programs stored in the storage unit to the host device, controls the display for selection of one of the user modes, and transmits information of the selected user mode to the host device, wherein the transmitted virtualization engine is recognized as a part of an operating system (OS) of the host device, and is programmed to drive a driver program corresponding to each of the user modes within the host device.

In accordance with another aspect of the present invention, a mobile terminal includes a display unit for providing a display image where user modes are selected, a storage unit for storing a virtualization engine and a plurality of programs implementing the user modes, and a controller which recognizes a communication connection to an external host device, controls the display unit for selection of one of the user modes, transmits information of the selected user mode, and transmits not only the virtualization engine stored in the storage unit but also a program implementing the selected user mode among the programs stored in the storage unit to the host device, wherein the transmitted virtualization engine is recognized as a part of an operating system (OS) of the host device, and is programmed to drive a driver program corresponding to each of the user modes within the host device.

In accordance with another aspect of the present invention, a mobile terminal includes a display unit for providing a display image where user modes are selected, a storage unit for storing a virtualization engine and a plurality of programs implementing the user modes, and a controller which controls the display for selection of one of the user modes, recognizes a communication connection to a host device, transmits information of the selected user mode to the host device, and transmits not only the virtualization engine stored in the storage unit but also a program implementing the selected user mode among the programs stored in the storage unit to the host device, wherein the transmitted virtualization engine is recognized as a part of an operating system (OS) of the host device, and is programmed to drive a driver program corresponding to each of the user modes in the host device.

In accordance with another aspect of the present invention, a method for controlling the host device includes recognizing a communication connection to a mobile terminal, receiving a virtualization engine and driver programs of individual user modes from the mobile terminal, and including the received virtualization engine and the received driver programs in a part of a host device operating system (OS), and operating a driver program corresponding to the user mode upon receiving user mode information from the mobile terminal.

In accordance with another aspect of the present invention, a method for controlling communication between a host device and a mobile terminal includes establishing a communication connection between the mobile terminal and the host device, transmitting a virtualization engine and driver programs of individual user modes from the mobile terminal to the host device, including the virtualization engine and the driver programs of individual user modes in a part of a host device operating system (OS), and deciding a user mode and operating a driver program corresponding to the decided user mode within the host device.

The communication connection between the host device and the mobile terminal may be formed through a universal serial bus (USB).

One of the user modes may include an Internet access mode.

When the mobile terminal is released from the host device and is then re-connected to the host device, the mobile terminal does not retransmit the virtualization engine and the driver programs to the host device, and at the same time a driver program corresponding to the user mode is automatically driven.

In accordance with another aspect of the present invention, a method for controlling a mobile terminal to be used through a host device includes transmitting a virtualization engine and driver programs of user modes of the mobile terminal to the host device; selecting one of the user modes; and transmitting information of the selected one user mode to the host device, wherein the transmitted virtualization engine is recognized as a part of an operating system (OS) of the host device, and is programmed to drive a driver program corresponding to each of the user modes within the host device.

In accordance with another aspect of the present invention, a mobile terminal includes a display unit which provides a display image used to select user modes; a storage unit which stores a virtualization engine and programs implementing the user modes; and a controller which transmits the virtualization engine and the programs stored in the storage unit to the host device, controls the display for selection of one of the user modes, and transmits information of the selected user mode to the host device, wherein the transmitted virtualization engine is recognized as a part of an operating system (OS) of the host device, and is programmed to drive a driver program corresponding to each of the user modes within the host device.

It is to be understood that both the foregoing general description and the following detailed description of the present invention are examples and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates an example mobile terminal and a host device according to one embodiment of the present invention.

FIG. 2 illustrates example user modes implemented in a mobile terminal according to one embodiment of the present invention.

FIG. 3 is a flow chart illustrating an operation relationship between a mobile terminal and a host device according to one embodiment of the present invention.

FIG. 4 is a flow chart illustrating an operation relationship between a mobile terminal and a host device according to another embodiment of the present invention.

FIG. 5 is a flow chart illustrating an operation relationship between a mobile terminal and a host device according to yet another embodiment of the present invention.

FIG. 6 is a flow chart illustrating an operation relationship between a mobile terminal and a host device according to yet another embodiment of the present invention.

FIG. 7 is a conceptual diagram illustrating some parts of an operating system (OS) contained in a host device according to the present invention.

FIG. 8 is a flow chart illustrating a method for controlling a mobile terminal to be used through a host device according to one embodiment of the present invention.

FIG. 9 is a flow chart illustrating a method for controlling a mobile terminal to be used through a host device according to another embodiment of the present invention.

FIG. 10 is a flow chart illustrating a method for controlling a mobile terminal to be used through a host device according to yet another embodiment of the present invention.

FIG. 11 is a block diagram illustrating internal components of a mobile terminal and a host device according to the present invention.

FIG. 12 is a detailed block diagram illustrating a mobile terminal according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts. Constituent components and operations of the present invention shown in the drawings will be disclosed only for illustrative purposes of the present invention, such that technical spirit, important constructions and operations of the present invention are not limited to only the following embodiments, and can also be applied to other embodiments.

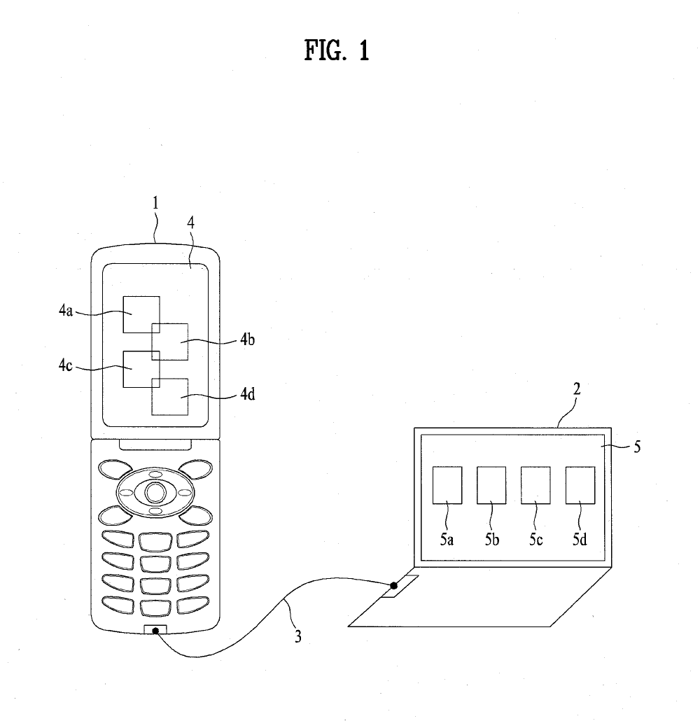

FIG. 1 illustrates an example mobile terminal 1 and a host device 2 according to the present invention. As shown in FIG. 1, the mobile terminal 1 may be connected to the host device 2 through a specific communication unit 3. For example, the communication unit 3 may be implemented with a universal serial bus (USB) (e.g., wired) or a Bluetooth protocol (e.g., wireless), and the scope of embodiments of the present invention is not limited thereto. Those skilled in the art will appreciate that various modifications, additions and substitutions are possible from this description.

The mobile terminal 1 includes a display 4 for implementing interactivity with a user. A variety of menu screens 4a, 4b, 4c, and 4d, for example, are provided to the user through the display 4. The host device 2 includes a display 5 for interactivity with a user, and provides the user with menu screens 5a, 5b, 5c, and 5d through the display 5. Other menu images can be implemented on the display as necessary.

Specifically, each display image contained in most mobile terminals 1 is configured in the form of a small screen, but the display contained in the host device 2 is generally configured in the form of a large screen. Accordingly, a user is more accustomed to executing a user mode through the host device 2, instead of executing a desired function or service (hereinafter referred to as a user mode) in the mobile terminal. As a result, demand for using the mobile terminal through the host device is increasing.

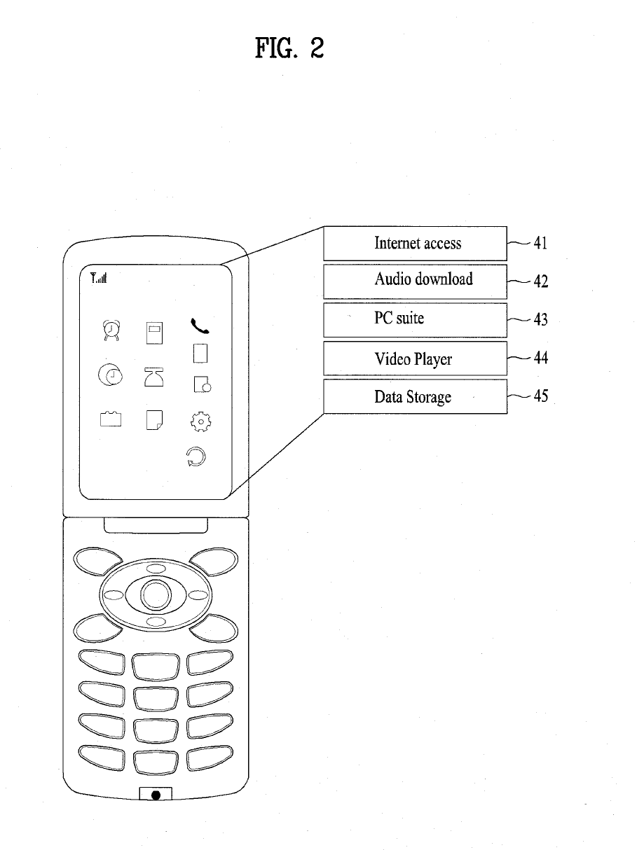

FIG. 2 illustrates example user modes implemented in a mobile terminal according to one embodiment of the present invention. A variety of user modes may be used as shown in FIG. 2. For example, an Internet access mode 41 capable of implementing Internet access of the host device 2 through the mobile terminal 1, an audio download mode 42 for allowing the mobile terminal 1 to download audio data from the host device 2 and using the mobile terminal 1 having the downloaded audio data, a PC suite mode 43 capable of exchanging information of the mobile terminal 1 for information of the host device 2, a video player mode 44 for implementing a video signal (e.g., a DMB, a DivX, or the like) stored in the mobile terminal 1 in the host device 2, and a data storage mode 45 for using the mobile terminal 1 as a storage medium may be used as user modes. However, it is obvious to those skilled in the art that the user modes are not limited to the above-described modes, and various user modes can be developed and used in different ways.

An object of the present invention is to provide a method for effectively using a mobile terminal 1 and a host device 2 under the environment in which the mobile terminal 1 communicates with the host device 2. Detailed embodiments in connection with the above object of the present invention will hereinafter be described with reference to the drawings.

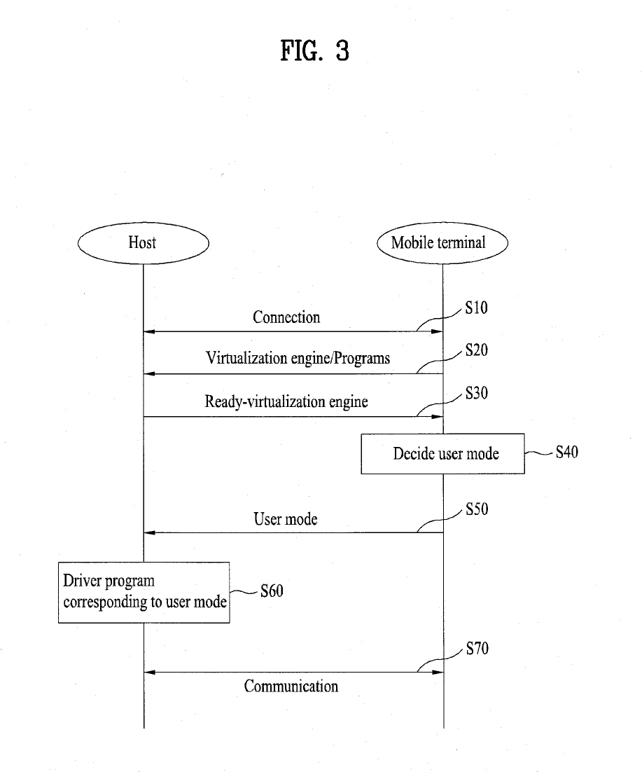

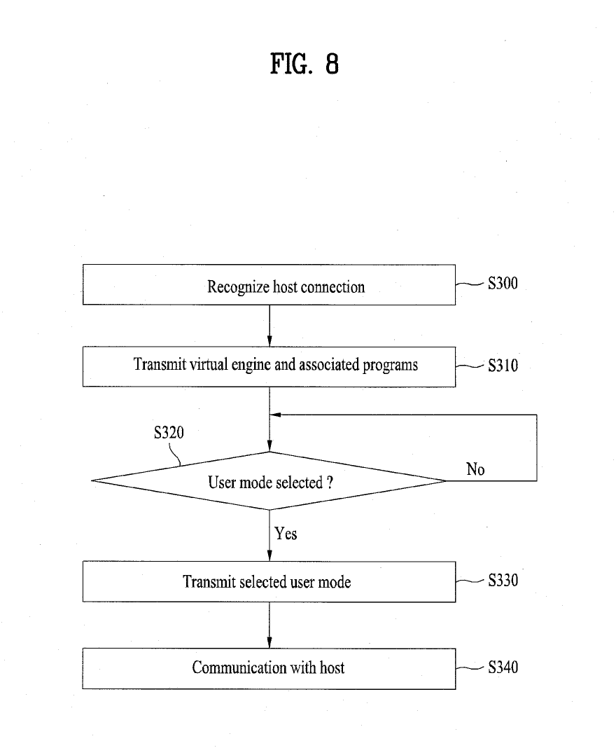

FIG. 3 is a flow chart illustrating an operation relationship between a mobile terminal and a host device according to one embodiment of the present invention. FIG. 8 is a flow chart illustrating a method for controlling a mobile terminal to be used through a host device according to one embodiment of the present invention.

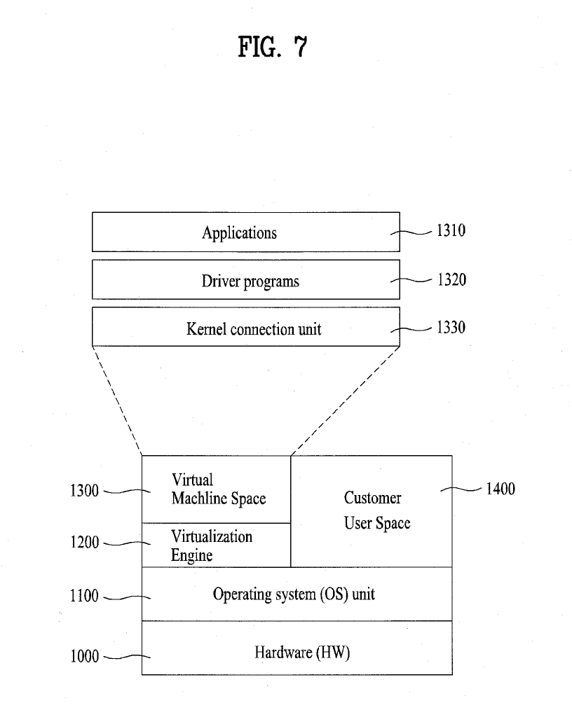

As shown in FIG. 3, if a mobile terminal is connected to a host device by a wired or wireless communication method at step S10, the mobile terminal transmits a virtualization engine and driver programs of individual user modes to the host device at step S20. The virtualization engine transmitted to the host device is recognized as a part of an operating system (OS) embedded in the host device. In other words, most host devices are operated by the operating system (OS), and the host device which has received the virtualization engine recognizes some parts of a new operating system (OS) and drives a mobile terminal as a recognizable peripheral device. Operations of the host device through the virtualization engine will be described later with reference to FIG. 7.

After the host device recognizes the virtualization engine as a part of the operating system (OS), it informs the mobile terminal of an available status of the virtualization engine (i.e., ready-virtualization engine) at step S30. Step S30 should be understood as a convenient operation of the host device. In case of a specific host device, this step S30 may be omitted as necessary.

After it is recognized that the mobile terminal can be used through the host device, the mobile terminal is controlled to select a user mode through the display 4 at step S40. For example, various user modes illustrated in FIG. 2 are provided as menu screens 4a to 4d, respectively, and a user is able to select any one of the user modes through the menu screens 4a to 4d.

If the user mode is decided by (or through) the mobile terminal, information of the decided user mode is transferred to the host device at step S50. Step S50 may be carried out by a predetermined communication protocol between the mobile terminal and the host device, or a command defined in a prescribed communication connection scheme (e.g., a USB) may also be used in step S50.

At step S60, the host device, which has received user mode information at step S50, drives a driver program corresponding to the received user mode information among a plurality of driver programs of individual user modes using the virtualization engine which was received at step S20. Therefore, the host device does not execute an additional installation program corresponding to a specific user mode, but executes pre-received driver programs of individual user modes through the virtualization engine. From the viewpoint of a user, regardless of which host device the mobile terminal is connected to, the user can freely use a desired user mode on the mobile terminal at any time without installing a specific execution driver program. If the driver program is driven, then the mobile terminal is able to communicate with the host device according to the selected user mode at step S70.

In a communication connection method between the host device and the mobile terminal according to the above-described embodiment, a method for controlling the mobile terminal may include the following steps illustrated in FIG. 8. In other words, for example, if a communication connection between the mobile terminal and the host device is recognized at step S300, a virtualization engine and driver programs of individual user modes are transferred to the host device at step S310. Thereafter, the mobile terminal is controlled to select the user mode. If a specific user mode is selected at step S320, the selected user mode is transferred to the host device at step S330. After that, the mobile terminal transmits and receives data corresponding to the selected user mode to/from the host device at step S340.

In a communication connection method between the host device and the mobile terminal according to one embodiment of the present invention, a method for controlling the host device can be implemented by the following steps. In other words, the method for controlling the host device includes: detecting a communication connection to the mobile terminal; receiving a virtualization engine and driver programs of individual user modes from the mobile terminal, and including the received virtualization engine and driver programs in a host-device operating system; and driving a driver program corresponding to each of the user modes upon receiving user mode information from the mobile terminal.

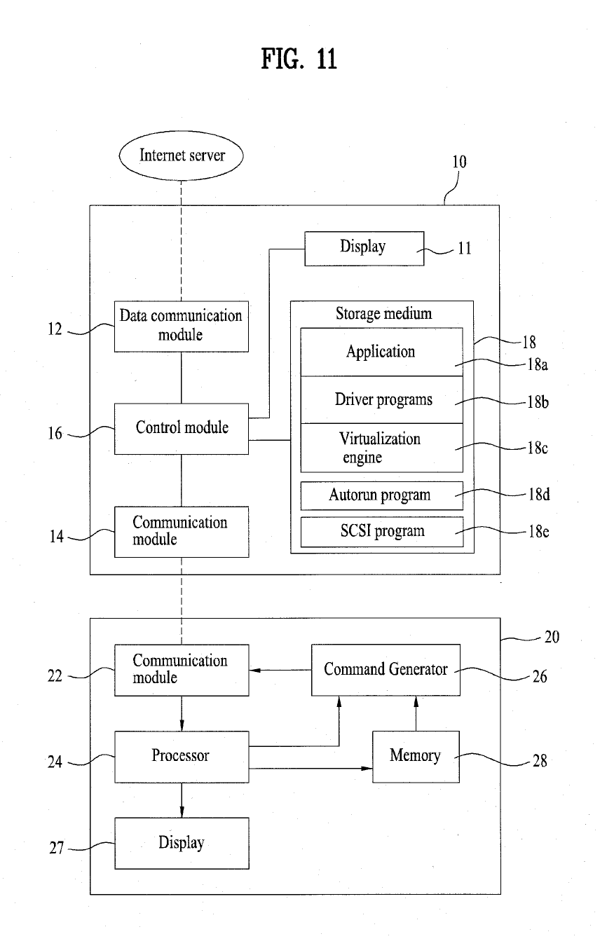

In association with the above-mentioned description, although the above embodiment and other embodiments to be disclosed have described that both the virtualization engine and driver program(s) are transmitted to the host device, the scope of the present invention is not limited to only this example, and is also applicable to other examples as necessary. In other words, only the virtualization engine is transmitted to the host device, driver programs are maintained in a storage medium 18 of FIG. 11 without any change, and the host device may read a corresponding driver program from the storage medium of the mobile terminal whenever the corresponding driver program is needed. In more detail, the virtualization engine and the driver program(s) are not all transmitted to the host device when the mobile terminal is initially connected to the host device, and the host device reads a necessary driver program corresponding to a user mode from the storage medium (See reference number ‘18’ of FIG. 11) of the mobile terminal whenever the user mode is selected, such that the host device and the mobile terminal can more effectively cope with the selected user mode.

Yet another embodiment equally applied to not only the above-described embodiment but also the following embodiments provides a method for controlling a mobile terminal and a host device when the mobile terminal is re-connected to the host device after it has been disconnected from the host device. If the mobile terminal is disconnected from the host device, operations of the virtualization engine transferred to the host device are temporarily suspended. After that, if the same mobile terminal is connected to the host device, a previous virtualization engine and previous driver programs are not retransmitted to the host device, and a driver program corresponding to a user mode can be automatically driven. In other words, if the mobile terminal is re-connected to the host device, step S20 is omitted, so that this embodiment can be more effectively implemented. For example, when developing software of the virtualization engine, an expiration period of a corresponding virtualization engine is pre-programmed into the host device. As a result, when the same mobile terminal is reconnected to the host device within a specific period of time, the virtualization engine can be automatically implemented without being retransmitted to the host device.

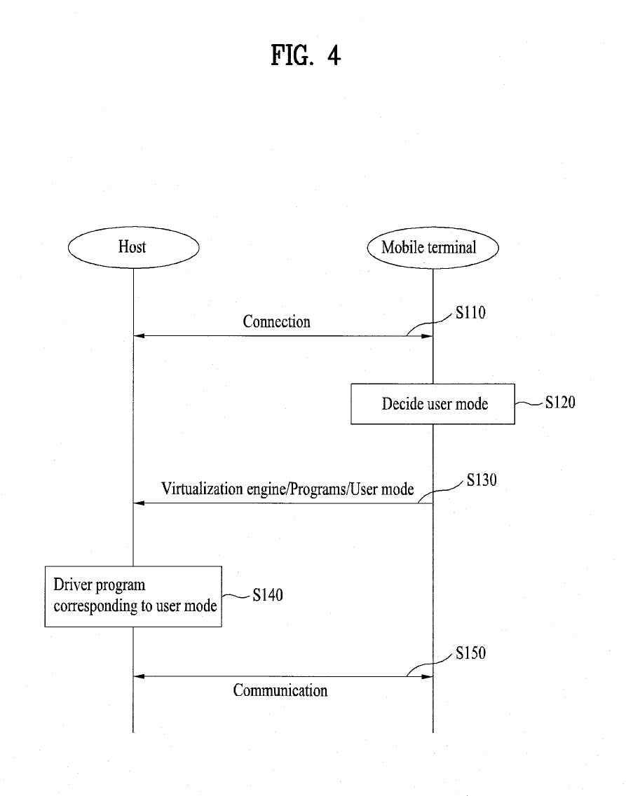

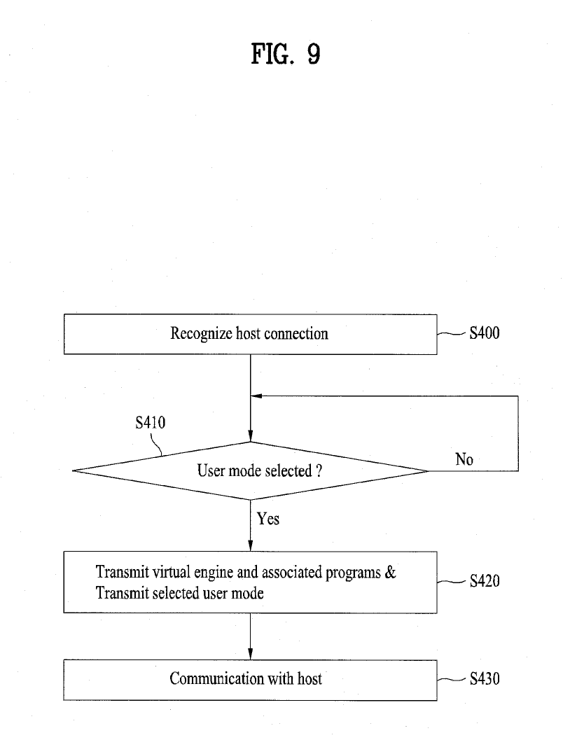

FIG. 4 is a flow chart illustrating an operation relationship between a mobile terminal and a host device according to another embodiment of the present invention. FIG. 9 is a flow chart illustrating a method for controlling a mobile terminal to be used through a host device according to another embodiment of the present invention.

As shown in FIG. 4, if the mobile terminal and the host device are connected to each other by a wired or wireless communication method at step S110, the mobile terminal is controlled to initially select a user mode at step S120. After that, the mobile terminal transmits not only information of the selected user mode but also a virtualization engine and driver programs of individual user modes to the host device at step S130.

After the host device receives user mode information at step S130, the host device drives a driver program corresponding to the received user mode information among driver programs of individual user modes using the received virtualization engine at step S140. Therefore, according to this embodiment illustrated in FIG. 4, the host device can execute pre-received driver programs of individual user modes through the virtualization engine without executing an additional installation program corresponding to a specific user mode. If the driver program is driven, then the mobile terminal and the host device can communicate with each other according to the selected user mode at step S150.

In another example in association with this embodiment, all driver programs corresponding to respective user modes are not transmitted to the host device at step S130, and only a driver program corresponding to the selected user mode can be transmitted to the host device at step S130. In this case, if the user mode is changed to another user mode, a driver program corresponding to the changed user mode may be retransmitted.

In a communication connection method between the host device and the mobile terminal according to the above-mentioned embodiment, a method for controlling the mobile terminal may include the following steps illustrated in FIG. 9. In other words, for example, if a communication connection between the mobile terminal and the host device is recognized at step S400, the mobile terminal is controlled to select a user mode. If a specific user mode is selected at step S410, then not only information of the selected user mode but also a virtualization engine and driver programs of individual user modes are transmitted to the host device at step S420. After that, the mobile terminal transmits and receives data corresponding to the selected user mode to/from the host device at step S430.

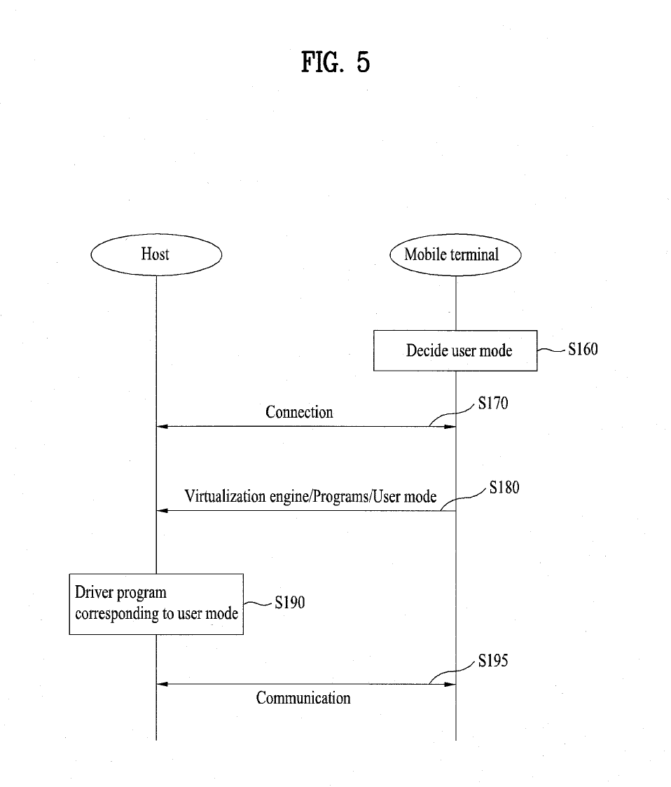

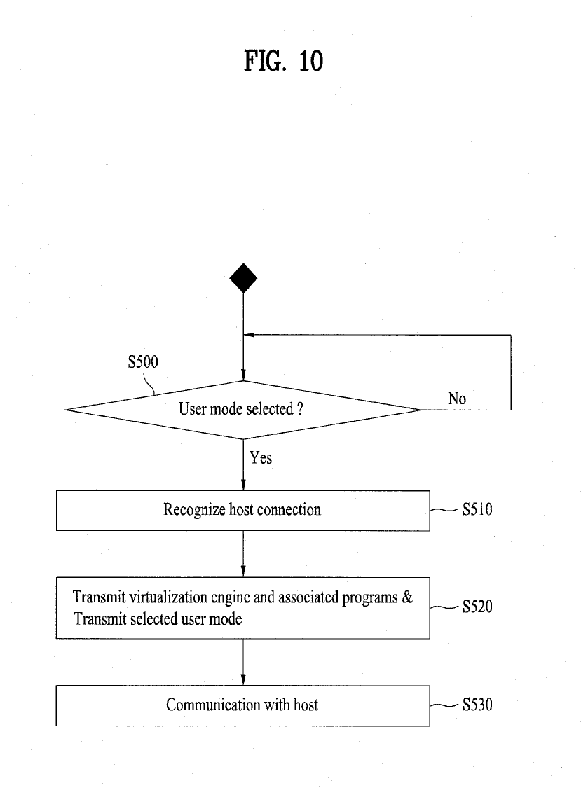

FIG. 5 is a flow chart illustrating an operation relationship between a mobile terminal and a host device according to yet another embodiment of the present invention. FIG. 10 is a flow chart illustrating a method for controlling a mobile terminal to be used through a host device according to yet another embodiment of the present invention.

As shown in FIG. 3, at step S160, the mobile terminal is controlled to initially select a user mode before it is connected to the host device by a wired or wireless communication method. Thereafter, if the mobile terminal is connected to the host device by a wired or wireless communication method at step S170, then the mobile terminal transmits not only information of the selected user mode but also a virtualization engine and driver programs of individual user modes to the host device at step S180.

After the host device receives user mode information at step S180, it drives a driver program corresponding to the received user mode information among driver programs of individual user modes using the received virtualization engine at step S190. Therefore, according to this embodiment illustrated in FIG. 5, the host device can execute pre-received driver programs of individual user modes using the virtualization engine without executing an additional installation program corresponding to a specific user mode. If the driver program is driven, then the mobile terminal and the host device can communicate with each other according to the selected user mode at step S195.

In another example in association with this embodiment, a user mode may be set to a default user mode at step S160. In other words, the above step S160 refers to a user mode, which has already been established in the mobile terminal before the mobile terminal has been connected to the host device by a user or systematically. Therefore, if the user desires to change a current user mode to another user mode after the mobile terminal and the host device are connected to each other, a user mode can be changed to another user mode according to the embodiment illustrated in FIG. 3 or FIG. 4.

In a communication connection method between the host device and the mobile terminal according to the above-described embodiment, a method for controlling the mobile terminal may include the following steps illustrated in FIG. 10. For example, a user mode is selected before the mobile terminal is connected to the host device by a wired or wireless communication method at step S500. Thereafter, if the mobile terminal is connected to the host device by a wired or wireless communication method at step S510, the mobile terminal transmits not only the selected user mode information but also a virtualization engine and driver programs of individual user modes at step S520. After that, the mobile terminal is controlled to communicate with the host device, so that it transmits and receives data corresponding to a corresponding user mode to/from the host device at step S530.

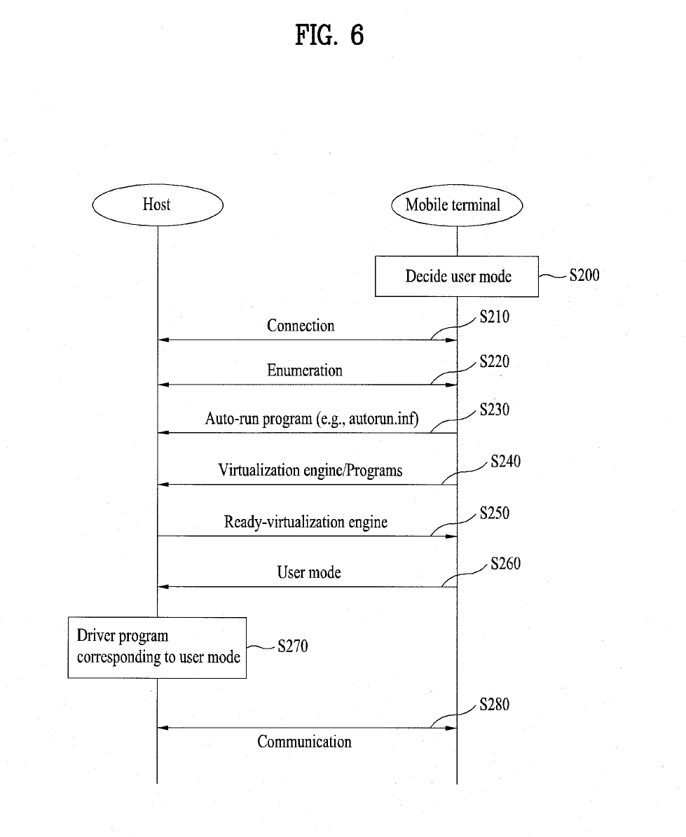

FIG. 6 is a flow chart illustrating an operation relationship between a mobile terminal and a host device according to yet another embodiment of the present invention. In particular, the following embodiment illustrated in FIG. 6 may be regarded as one example of the above-mentioned embodiment of FIG. 5.

In association with the above-mentioned description, the embodiment of FIG. 6 may use a universal serial bus (USB), for example, as a communication means (or a medium) between a mobile terminal and a host device, but such is not required and a wireless means (or a medium) may also be used. In addition, according to this embodiment of FIG. 6, before the mobile terminal and the host device communicate with each other, a default user mode may be set to a mode of CDROM used as a storage medium from among a plurality of USB modes, for example.

As shown in FIG. 6, if the mobile terminal is connected to the host device according to a USB communication scheme at step S210, the host device performs a process for checking (or determining) a connection mode, a USB mode for example, of the mobile terminal. This process is referred to as an enumeration process. If the enumeration process is completed, the host device determines a mode of the mobile terminal to be a mode A (e.g., a CDROM mode), for example, at step S220. After the host device performs the enumeration process of step S220, the mobile terminal transmits an autorun program to the host device at step S230. The autorun program includes a program for automatically driving a predetermined USB mode in the host device.

Thereafter, as previously stated in the above-mentioned embodiments of FIGS. 3 to 5, the mobile terminal transmits a virtualization engine and driver programs of individual user modes to the host device at step S240. The host device receives the virtualization engine and the driver programs, and reports an available status of the virtualization engine to the mobile terminal at step S250. Needless to say, step S250 may also be omitted because it is considered to be an expedient operation of the host device.

After that, if a user of the mobile terminal desires to change a user mode, the user re-selects a desired user mode (the user mode selection has already been described in the embodiment of FIG. 3), and information of the re-selected user mode is transferred to the host device at step S260.

After the host device receives user mode information at step S260, it drives a driver program corresponding to the received user mode information among driver programs of individual user modes using the received virtualization engine at step S270. If the driver program is driven, then the mobile terminal and the host device can communicate with each other according to the re-selected user mode at step S280.

As a result, according to this embodiment illustrated in FIG. 6, when the host device is initially connected to the mobile terminal, an execution program (also called a run program) corresponding to a default user mode (for example, a CDROM mode) is automatically installed on the host device at step S230. Thereafter, when a user mode is changed to another user mode, the host device does not execute an additional installation program corresponding to the changed user mode, but can execute pre-received driver programs of individual user modes through the virtualization engine.

FIG. 7 is a conceptual diagram illustrating some parts of an operating system (OS) contained in a host device according to the present invention. In particular, FIG. 7 illustrates how the virtualization engine and the driver programs are used in the host device in various ways.

In case of hierarchically analyzing the entire system operating the host device, the entire system is classified into a hardware (HW) unit 1000 including various chips and memories and an operating system (OS) unit 1100 for controlling operations of the host device. Specifically, the operating system (OS) unit 1100 includes software for controlling all operations of the host device, and the addition of the OS unit refers to a new host device that can be operated and driven.

According to the above-mentioned embodiment, a virtualization engine 1200 transferred from the mobile terminal is recognized as a part (or being a part) of the OS unit 1100. In other words, according to virtualization technology, a new operating system (OS) not present in an initial operating system (OS) can be recognized as if it were present from the beginning of operations. In case of using the virtualization technology in implementation of a user mode according to the present invention, there is no need to additionally install a driver program corresponding to the user mode of the mobile terminal.

Driver programs 1320 and other applications 1310, which are present in a virtual machine space 1300, can be driven by the virtualization engine 1200. Reference number 1330 represents a kernel connection unit serving as a new operating system (OS), so that the virtualization engine 1200, the driver programs 1320, and the other applications 1310 are interconnected through the kernel connection unit, as well known to those skilled in the art to which a design of the operating system (OS) pertains.

FIG. 11 is a block diagram illustrating internal components of a mobile terminal 10 and a host device 20 according to the present invention. The mobile terminal 10 of FIG. 11 is designed to support all operations between the mobile terminal and the host device, where the operations between the mobile terminal and the host device have been disclosed in the above-mentioned embodiments. Therefore, in the case where a user desires to apply any one or some of the above-mentioned embodiments to the mobile terminal, it is obvious to those skilled in the art that the above case can be implemented in various ways.

The mobile terminal 10 includes a display 11 for interactivity with a user, a data communication module 12 for implementing data communication by accessing a wired or wireless communication network, a storage medium 18 storing a variety of programs, a communication module 14 communicating with an external host device, and a control module 16 for controlling constituent elements and performing control operations of the embodiment of the present invention.

In association with the above-mentioned description, a variety of programs may be stored in the storage medium 18. For example, a virtualization engine 18c, a plurality of driver programs 18b, and an application 18a may be stored in the storage medium 18. In addition, in order to support the embodiment illustrated in FIG. 6, an autorun program 18d (e.g., cd-autorun program), and a SCSI program 18e may be stored in the storage medium 18. The above storage medium 18 may be embedded in the mobile terminal, or may be an auxiliary memory which can be detachably connected to the mobile terminal. As previously stated above, the communication module 14 can be implemented via a USB, or a wireless manner.

The mobile terminal receives data from the host device 20 through a communication module 14, and transmits the received data to an external server (or a terminal computer) connected to a communication network through a data communication module 12. The mobile terminal 10 transmits data of the external server to the host device 20 through an opposite path.

The host device 20 includes a communication module 22 for communicating with an external mobile terminal 10, a processor 24 for processing data received from the mobile terminal 10 and controlling all operations of the host device 20, and a memory 28 for temporarily or permanently storing associated programs and data. The host device 20 may further include a command generator 26 for generating a command used for communication with the mobile terminal 10. Although the processor 24 and the command generator 26 are separated from each other in FIG. 11 for convenience of description and better understanding of the present invention, it is obvious to those skilled in the art that functions of the processor 24 and the command generator 26 can be simultaneously performed in a process for designing a real product. The host device 20 may include a display 27 to implement a user mode of the mobile terminal 10.

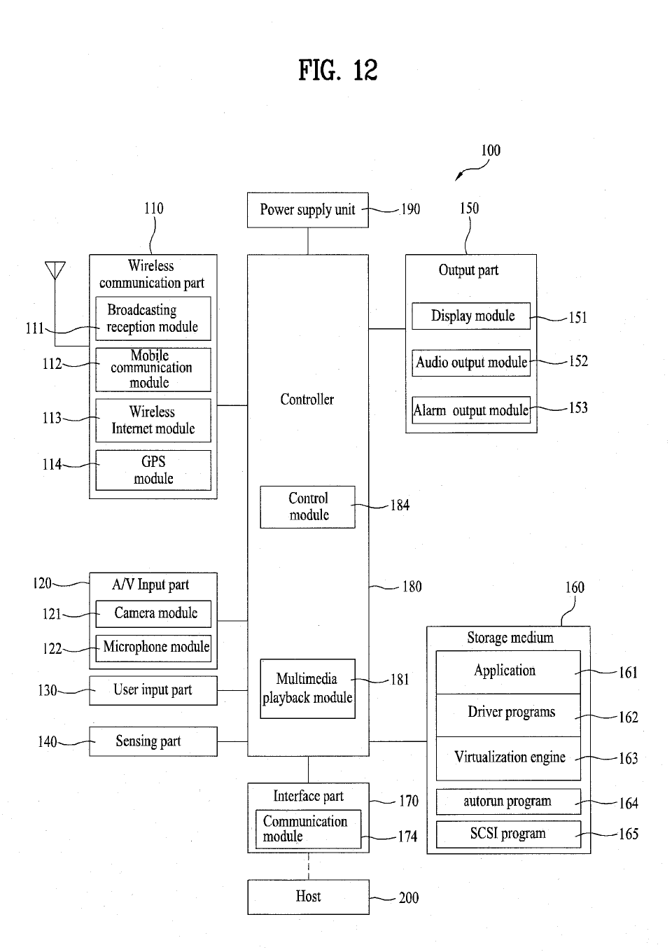

FIG. 12 is a detailed block diagram illustrating a mobile terminal according to the present invention. In more detail, FIG. 12 illustrates an example mobile terminal 100 in which a communication modem function is embedded. In other words, the mobile terminal of FIG. 12 may be a mobile phone, a smart phone, a notebook computer, a receiver for digital broadcasting data, a personal digital assistant (PDA), a portable multimedia player (PMP), a navigator, or the like. The mobile terminal 100 may be connected to a wireless communication network, and may be connected to a content provider for providing a variety of Internet services over the wireless communication network.

The mobile terminal 100 illustrated in FIG. 12 may include a wireless communication part 110, an audio/video (A/V) input part 120, a user input part 130, a sensing part 140, an output part 150, a storage medium 160, an interface part 170, a controller 180, a power supply unit 190, and the like. In case of implementing the aforementioned constituent elements in an actual application example, two or more constituent elements may be integrated in one element as necessary, or one element may be divided into two or more constituent elements as necessary. Hereinafter, the above-mentioned constituent elements will be described in detail with reference to the drawings.

The wireless communication part 110 may include a broadcasting reception module 111, a mobile communication module 112, a wireless Internet module 113, and a global positioning system (GPS) module 114. The broadcasting reception module 111 receives a broadcast signal and/or broadcasting-associated information from an external broadcasting management server (not shown) over a broadcasting channel. The broadcasting channel may include a satellite channel and a terrestrial channel. The broadcasting management server may represent either a server for generating and transmitting a broadcasting signal and/or broadcasting-associated information or another server for receiving pre-generated broadcasting signal and/or broadcasting-associated information and transmitting the received broadcasting signal and/or the received broadcasting-associated information to a mobile terminal. In this case, the broadcasting-associated information may represent various information associated with a broadcasting channel, a broadcasting program, or a broadcasting service provider. The broadcasting signal may include a TV broadcasting signal, a radio broadcasting signal, and a data broadcasting signal, and may also include another broadcasting signal configured in the form of a combination of the data broadcasting signal and one of the TV broadcasting signal and the radio broadcasting signal. In the meantime, the broadcasting-associated information may also be provided over a mobile communication network. In this case, the broadcasting-associated information may be received by the mobile communication module 112.

The broadcasting-associated information may be constructed in various formats. For example, the broadcasting-associated information may be constructed in the form of an electronic program guide for digital multimedia broadcasting (DMB) or an electronic service guide (ESG) for digital video broadcast-handheld (DVB-H). The broadcasting reception module 111 receives a broadcasting signal using a variety of broadcasting systems. Specifically, the broadcasting reception module 111 may receive a digital broadcasting signal using a digital broadcasting system such as, particularly, digital multimedia broadcasting-terrestrial (DMB-T), digital multimedia broadcasting-satellite (DMB-S), media forward link only (MediaFLO), digital video broadcast-handheld (DVB-H), integrated services digital broadcast-terrestrial (ISDB-T), and the like. Of course, the broadcasting reception module 111 is configured to be appropriate for not only the above-mentioned digital broadcasting system but also for all broadcasting systems providing broadcasting signals. The broadcasting signal and/or the broadcasting-associated information received through the broadcasting reception module 111 may be stored in the storage medium 160.

In addition, the mobile terminal module 112 transmits and receives a radio frequency (RF) signal to/from at least one of a base station, an external mobile terminal, and a server over a mobile communication network. In this case, the RF signal may include a voice call signal, an image communication call (also called an audiovisual communication call) or various-formatted data based on transmission and reception of text- and multimedia-messages. The wireless Internet module 113 represents a module for wireless Internet access. In this case, the wireless Internet module 113 may be embedded in the mobile terminal or may be installed at the outside of the mobile terminal. In addition, a global positioning system (GPS) module 114 receives navigation information from a plurality of artificial satellites.

The audio/video (A/V) input part 120 is used to enter an audio signal or a video signal in the mobile terminal. For example, the A/V input part 120 may include a camera module 121, a microphone module 122, and the like. The camera module 121 processes an image frame, such as a still image or a moving image, obtained from an image sensor in an image communication mode (also called an audiovisual communication mode) or a photographing mode. The processed image frame may be displayed on a display module 151. The image frame processed in the camera module 121 may be stored in a storage medium 160 or may be transmitted to the outside through the wireless communication part 110. If necessary, two or more camera modules 121 may be used according to a configuration type of a mobile terminal. The microphone module 122 receives an external sound signal through a microphone at a communication mode (also called a call mode), a recording mode, or a voice recognition mode, and converts the received external sound signal into electrical voice data. In the communication mode, the processed voice data may be converted into another data capable of being transmitted to a mobile communication base station through the mobile communication module 112. The microphone module 122 may implement a variety of noise removing algorithms for removing noise generated in a process of receiving an external sound signal.

The user input part 130 generates key input data entered by a user who desires to control operations of the mobile terminal. The user input part 130 may include a key pad, a dome switch, a touchpad (including a static-pressure type and an electrostatic type), a jog wheel, a jog switch, and the like. Specifically, when the touchpad and the display module 151 to be described later are formed in a layer structure, they are called a touch screen.

The sensing part 140 generates a sensing signal for controlling an operation of the mobile terminal 100 by detecting a variety of current states of the mobile terminal 100, for example, an opening or closing state of the mobile terminal 100, a position of the mobile terminal 100, and information indicating whether a user touches the mobile terminal 100. For example, when the mobile terminal 100 is a slide phone type, the sensing part 140 can sense whether the slide phone is open or closed. Further, the sensing part 140 can perform a function of sensing whether power is applied to the power supply unit 190 and whether the interface part 170 is coupled to an external appliance.

The interface part 170 serves as an interface with all external appliances connected to the mobile terminal 100. For example, external appliances connected to the mobile terminal 100 may include a wired/wireless head set, an external charger, a wired/wireless data port, a card socket (e.g., a memory card, or a subscriber identification module (SIM)/user identity module (UIM) card), an audio Input/Output (I/O) terminal, a video I/O terminal, and an earphone. The interface unit 170 receives data or power from external appliances to transfer the data or the power to each of constituent elements contained in the mobile terminal 100, or transmits internal data of the mobile terminal 100 to external appliances.

The output part 150 outputs an audio signal, a video signal, or an alarm signal, and may include a display module 151, an audio output module 152, an alarm output module 153, and the like. The display module 151 displays information processed in the mobile terminal 100. For example, when the mobile terminal 100 is in a communication mode, the mobile terminal 100 displays a user interface (UI) or a graphical user interface (GUI) related to communication. When the mobile terminal 100 is in an audiovisual communication mode (i.e., an image communication mode) or a photographing mode, the mobile terminal 100 displays each or both of a photographed image and a received image and displays the UI and the GUI. As described above, when the display module 151 and the touchpad form a touch screen in a layer structure, the display module 151 may be used as an input device as well as an output device. The display module 151 may include at least one of a liquid crystal display (LCD), a thin film transistor-liquid crystal display (TFT-LCD), an organic light-emitting diode display, a flexible display, and a three-dimensional (3D) display. According to an implementation form of the mobile terminal 100, the mobile terminal 100 may include at least two display modules 151. For example, the mobile terminal 100 may include both an external display module (not shown) and an internal display module (not shown). In a call signal reception mode, a communication mode or a recording mode, a voice recognition mode, and a broadcasting reception mode, the audio output module 152 outputs audio data received from the wireless communication part 110 or stored in the storage medium 160. Further, the audio output module 152 outputs a sound signal related to a function performed in the mobile terminal 100, for example, a call signal reception sound and a message reception sound. The audio output module 152 may include a speaker, a buzzer, and the like. The alarm output module 153 outputs a signal notifying that an event has been generated in the mobile terminal 100. For example, the event generated in the mobile terminal 100 may include reception of a call signal requesting a phone call, message reception, key signal input, an alarm sound notifying a predetermined time, and the like. The alarm output module 153 outputs a signal notifying generation of an event in other forms except for audio and video signals. For example, the alarm output module 153 may output a signal in a vibration form. When a call signal is received or a message is received, the alarm output module 153 may output a vibration in order to notify that a call signal is received or a message is received. Otherwise, when the key signal is input, the alarm output module 153 may output a vibration as a feedback to key signal input. A user can recognize whether an event is generated through such vibration output. A signal notifying generation of an event may be output through the display module 151 or the audio output module 152.

The storage medium 160 may store a program for processing and controlling the controller 180 and perform a function for temporarily storing input or output data (for example, a phonebook, a message, a still image, and a moving image). The storage medium 160 may include a storage medium of at least one type of a flash memory, a hard disk, a multimedia card micro type, a card type memory (for example, SD or XD memory), a RAM, and a ROM. Further, the mobile terminal 100 may operate web storage for performing a storage function of the storage medium 160 over the Internet.

The controller 180 generally includes a control module 184 for controlling the overall operation of the mobile terminal 100. For example, the controller 180 performs control and processing related to voice communication, data communication, and audiovisual communication (or image communication). Further, the controller 180 may include a multimedia playback module 181 for reproducing multimedia data. The multimedia playback module 181 may be implemented via hardware provided within the controller 180 or software independent of the controller 180. Further, the controller 180 identifies whether an object (e.g., a user's finger) directly touches a touch screen or indirectly touches a touch screen by approaching close to the touch screen, so that it can change either the size of a screen displayed on the touch screen or an area of a display screen. For this operation, the controller 180 may form a scroll bar or a mini-map on the touch screen in order to adjust the size or area of a display screen.

The power supply unit 190 is connected to an external power source and an internal power source under the control of the controller 180 to supply power necessary for operating each of constituent elements.

A control method for use in the mobile terminal 100 according to the present invention will hereinafter be described in detail with reference to FIG. 12. The storage medium 160 contained in the mobile terminal 100 includes a virtualization engine 163, a plurality of driver programs 162, and an application 161. In addition, in order to support the embodiment illustrated in FIG. 6, an autorun program 164, and a SCSI program 165 may be stored in the storage medium 160. The storage medium 160 may be embedded in the mobile terminal, or may be an auxiliary memory which can be detachably connected to the mobile terminal.

If the mobile terminal 100 is connected to an external host device 200 through a communication module 174, the controller 180 transmits the above-mentioned virtualization engine 163 and the driver programs 162 to the host device 200. In addition, the controller 180 controls a user mode to be selected through the display module 151, and transmits information of the selected user mode to the host device 200. Thereafter, when the host device 200 can use the virtual engine, the controller 180 performs data communication corresponding to a user mode with the host device through the communication module 174.

As apparent from the above description, according to the above-mentioned embodiments of the present invention, a mobile terminal can be effectively used through a host device.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for controlling a mobile terminal to be used through a host device, the method comprising:
transmitting a virtualization engine and driver programs of user modes of the mobile terminal to the host device;
selecting one of the user modes; and
transmitting information of the selected one user mode to the host device,
wherein the transmitted virtualization engine is recognized as a part of an operating system (OS) of the host device, and is programmed to drive a driver program corresponding to each of the user modes within the host device.

2. The method according to claim 1, further comprising recognizing a communication connection to the host device.

3. The method according to claim 2, wherein the communication connection between the host device and the mobile terminal is formed through a universal serial bus (USB).

4. The method according to claim 1, wherein the selecting of the one of the user modes is performed before the transmitting of the information.

5. The method according to claim 1, wherein the transmitting of the virtualization engine and the driver programs, and the transmitting of the information of the selected user mode are performed together.

6. The method according to claim 1, further comprising:
determining a connection mode of the mobile terminal;
determining the selected user mode; and
transmitting an autorun program to drive the connection mode.

7. The method according to claim 1, wherein one of the user modes includes an Internet access mode.

8. The method according to claim 1, further comprising:
automatically driving, when the mobile terminal is released from the host device and is then re-connected to the host device, a driver program corresponding to the selected one user mode without re-transmitting the virtualization engine.

9. A mobile terminal, comprising:
a display unit which provides a display image used to select user modes;
a storage unit which stores a virtualization engine and programs implementing the user modes; and
a controller which transmits the virtualization engine and the programs stored in the storage unit to the host device, controls the display for selection of one of the user modes, and transmits information of the selected user mode to the host device,
wherein the transmitted virtualization engine is recognized as a part of an operating system (OS) of the host device, and is programmed to drive a driver program corresponding to each of the user modes within the host device.

10. The mobile terminal according to claim 9, wherein the controller further recognizes a communication connection to an external host device.

11. The mobile terminal according to claim 10, further comprising:
a universal service bus (USB) module which establishes the communication connection to the host device.

12. The mobile terminal according to claim 9, wherein controller controls the display for the selection of one of the user modes before transmitting the information of the selected user mode to the host device.

13. The mobile terminal according to claim 9, wherein the controller transmits the virtualization engine and the driver programs together with the information of the selected user mode.

14. The mobile terminal according to claim 9, wherein the controller further determines a connection mode of the mobile terminal, determines the selected user mode, and transmits an autorun program to drive the connection mode.

15. The mobile terminal according to claim 9, wherein one of the user modes includes an Internet access mode.

16. The mobile terminal according to claim 9, wherein the controller, when the mobile terminal is released from the host device and is then re-connected to the host device, automatically drives a driver program corresponding to the selected user mode without re-transmitting the virtualization engine.

17. The mobile terminal according to claim 9, wherein the controller also transmits a program implementing the selected user mode among the programs stored in the storage unit to the host device.
